(19) United States
(12) Patent Application Publication
(10) Pub. No.: US 2016/0299501 A1
(43) Pub. Date: Oct. 13, 2016

(54) METHOD FOR ADJUSTING THE DIRECTION OF HEAD END OF AIRCRAFT AND REMOTE CONTROL AIRCRAFT USING THE SAME

(71) Applicant: PEGATRON CORPORATION, Taipei City (TW)

(72) Inventors: HAO-YUNG CHANG, Taipei City (TW); YU-CHANG CHEN, Taipei City (TW); CHUN-CHIH CHEN, Taipei City (TW); CHUN-WEI WANG, Taipei City (TW); YU-CHENG CHANG, Taipei City (TW); CHIA-HO TING, Taipei City (TW)

(21) Appl. No.: 15/086,963

(22) Filed: Mar. 31, 2016

(30) Foreign Application Priority Data
Apr. 13, 2015 (TW) 104111735

(51) Int. Cl. G05D 1/00; B64C 39/02; B64C 1/06; G01S 5/02

(52) U.S. Cl. CPC G05D 1/0011; G01S 5/0284; B64C 39/024; B64C 1/06; B64C 2201/146; B64C 2201/127

(57) ABSTRACT

A method for adjusting the direction of a head end is disclosed. The method for adjusting the direction of the head end is applied to a remote control aircraft for controlling the remote control aircraft to rotate in the direction of an electronic device after the remote control aircraft receives a wireless signal transmitted by the electronic device, such that the remote control aircraft is first oriented toward the electronic device and flies in a direction chosen by a user.

### BACKGROUND

1. Technology Field

The present disclosure relates to a method for adjusting the direction of a head end of a remote control aircraft and the remote control aircraft using the same, and particularly to a method and a remote control aircraft that can keep a head end of the remote control aircraft oriented toward a user while the user operates the remote control aircraft.

2. Description of the Related Art

The traditional operation of a remote control aircraft has a major defect. That is, when a head end of an aircraft is not oriented toward a user, if the direction of the head end is not first adjusted to point toward the user, the user will need to perform different operations and manipulate the controls according to the direction of the head end of the aircraft while operating the aircraft, which is counterintuitive. For example, assuming the aircraft is to the north of the user and that the head end of the aircraft is oriented south (i.e., facing the user), the user can use a down button on the remote control device to control the aircraft to fly south (i.e., toward the user). However, when the head end of the aircraft is oriented west, pressing the down button on the remote control device will cause the aircraft to fly east, rather than to fly in the direction of the user.

Accordingly, it would significantly improve the aforementioned inconvenience if the head end of the remote control aircraft could consistently point toward the user during the flight of the remote control aircraft.

### SUMMARY

It is a major objective of the present disclosure to provide a method for adjusting the direction of a head end during the operation of a remote control aircraft such that the head end is automatically oriented toward the user.

It is another objective of the present disclosure to provide a remote control aircraft using the adjustment method described above.

To achieve the major objective described above, the method for adjusting the direction of a head end in the present disclosure is applied to the remote control aircraft and used for adjusting the direction of a head end of a remote control aircraft body, such that the head end of the aircraft body is able to be oriented toward an electronic device. The aircraft body is provided with a plurality of antennas. The adjustment method of the present disclosure includes the following steps: receiving a wireless signal transmitted by an electronic device through each of the antennas; determining whether a head end of a remote control aircraft body is oriented toward the electronic device according to the strength of the wireless signals received by each of the antennas; if not, controlling the head end of the aircraft body to rotate in the direction of the electronic device; if yes, keeping the head end oriented toward the electronic device.

The present disclosure further provides a remote control aircraft which can be controlled to fly and move by a user through an electronic device. The remote control aircraft of the present disclosure includes an aircraft body, a plurality of antennas, and a control unit. The aircraft body includes a head end, a plurality of antennas disposed on the aircraft body for receiving a wireless signal transmitted from an electronic device, and a control unit disposed on the aircraft body and electrically connected to the plurality of antennas. The control unit is used for determining whether the head end of the aircraft body is oriented toward the electronic device according to the strength of a wireless signal received by each of the antennas, and in the case that the head end of the aircraft body is not oriented toward the electronic device, used for controlling the head end to rotate in the direction of the electronic device such that the head end is oriented toward the electronic device.

### BRIEF DESCRIPTION OF THE DRAWINGS

FIG. 1 is a view showing a user operating a remote control aircraft with an electronic device;

FIG. 2 is a top view of the remote control aircraft of the present invention;

FIG. 3 is a flow chart showing steps of a method for adjusting the direction of a head end according to the present invention;

FIG. 4 is a view showing an operation interface for the user to input a control command;

FIG. 5 is a view showing that the head end of the aircraft body is not oriented toward the electronic device; and

FIG. 6 is a view showing the head end of the aircraft body oriented toward the electronic device after rotation.

### DETAILED DESCRIPTION OF THE PREFERRED EMBODIMENT

Hereafter, the technical content of the present invention will be better understood with reference to preferred embodiments.

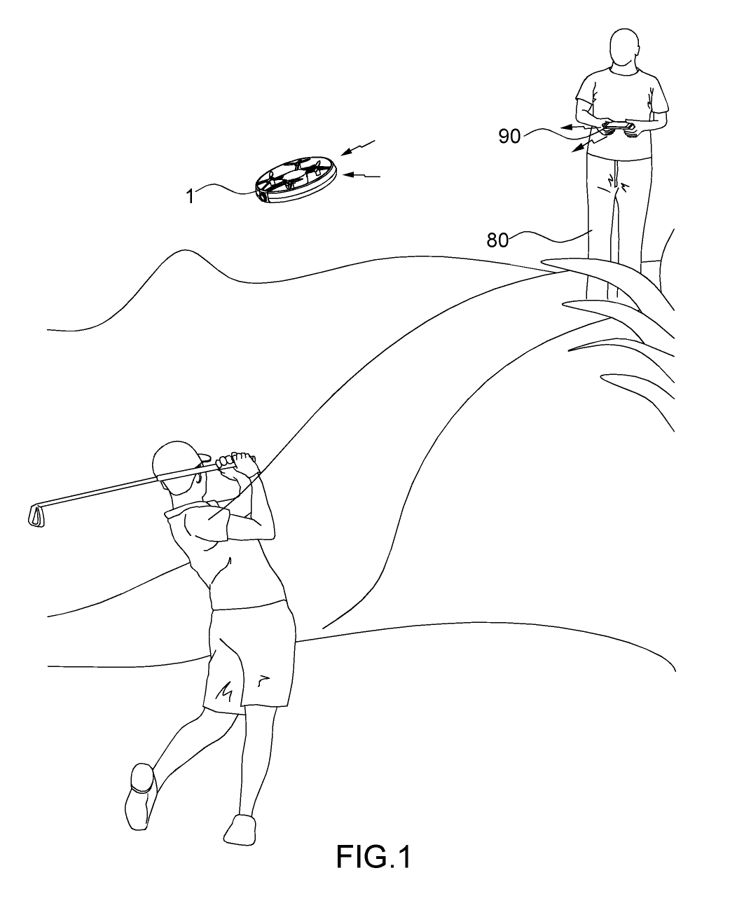

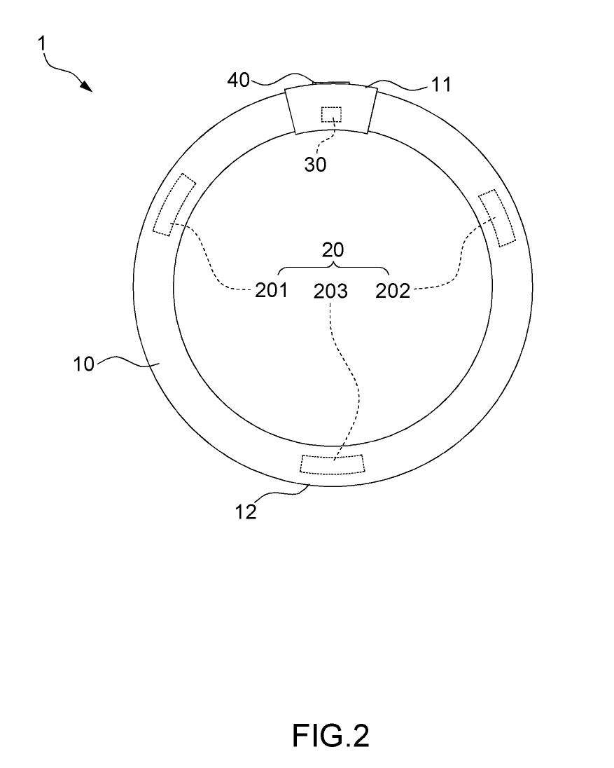

Please first refer to FIGS. 1 and 2, wherein FIG. 1 is a view showing a user operating a remote control aircraft with an electronic device; FIG. 2 is a top view of the remote control aircraft of the present invention.

As shown in FIG. 1, a remote control aircraft 1 disclosed in the present invention can be remotely controlled to fly by a user 80 operating an electronic device 90. In a specific embodiment of the present invention, the electronic device 90 is a smart phone, which includes a software program (not shown); when a processor (not shown) of the electronic device 90 loads and executes the software program, the electronic device 90 can be used by the user for controlling the flight and movement of the remote control aircraft 1. As shown in FIGS. 1 and 2, in an embodiment of the present invention, the remote control aircraft 1 of the present invention includes an aircraft body 10, a plurality of antennas 20, a control unit 30 and a camera 40.

The aircraft body 10 includes a head end 11 and a tail end 12. In this embodiment, the aircraft body 10, as shown in FIG. 2, is a disc, but the present invention is not limited thereto.

The antennas 20 are disposed at different positions of the aircraft body 10 respectively and used for receiving a wireless signal transmitted from the electronic device 90. In this embodiment, the number of the antennas 20 is three, including a first antenna 201, a second antenna 202 and a third antenna 203. Specifically, the first antenna 201 and the second antenna 202 are correspondingly disposed at the left and right sides of the aircraft body 10, and the distance from the first antenna 201 to the head end 11 of the aircraft body 10 is equal to the distance from the second antenna 202 to the head end 11, and the distances are respectively greater than the distances from the first antenna 201 and the second antenna 202 to the tail end 12. The third antenna 203 is adjacent to the tail end 12 of the aircraft body 10. The distance between any two of the three antennas 201, 202, 203 is equal to any other, and the distance to the center of the disc is also equivalent. In other words, the three antennas 201, 202, 203 are placed at intervals of 120 degrees with each other. However, the number and placement of the antennas 20 of the present invention are not limited thereto. For example, the angle between the correspondingly disposed first antenna 201 and the second antenna 202 may be 100°, in which case the angle between either the first antenna 201 or the second antenna 202 and the third antenna 203 is 130°. Additionally, in other embodiments, the third antenna 203 may be omitted.

The control unit 30 is disposed on the aircraft body 10 and electrically connected to the antennas 20. The control unit 30 is used for determining whether the head end 11 of the aircraft body 10 is oriented toward the electronic device 90 according to the strengths of the wireless signals received by the first antenna 201, the second antenna 202 and the third antenna 203, and when the head end 11 of the aircraft body 10 is not oriented toward the electronic device 90, for controlling the aircraft body 10 to rotate such that the head end 11 of the aircraft body 10 is oriented toward the electronic device 90. Hereinafter, how the control unit 30 determines whether the head end 11 of the aircraft body 10 is oriented toward the electronic device 90 in accordance with the strengths of the wireless signals received by the plurality of antennas 20 will be described in more detail. In a specific embodiment of the present invention, the control unit 30 is a microprocessor, but the present invention is not limited thereto.

The camera 40 is adjacent to the head end 11 of the aircraft body 10 for capturing images. The captured images can be transmitted to the electronic device 90 by an image processing system (not shown) and a wireless transmission module (not shown) to allow a user to view the images captured by the camera 40 immediately.

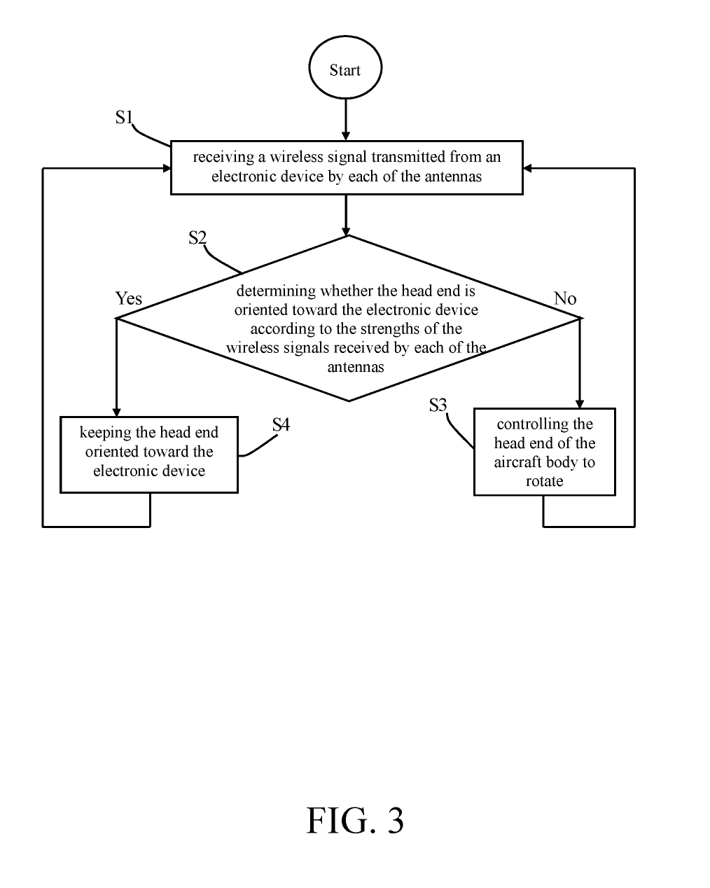

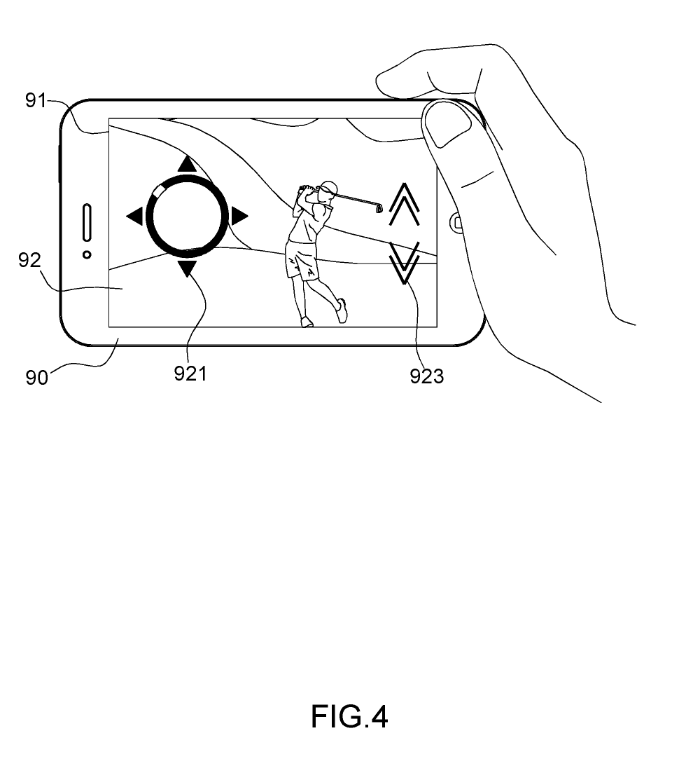

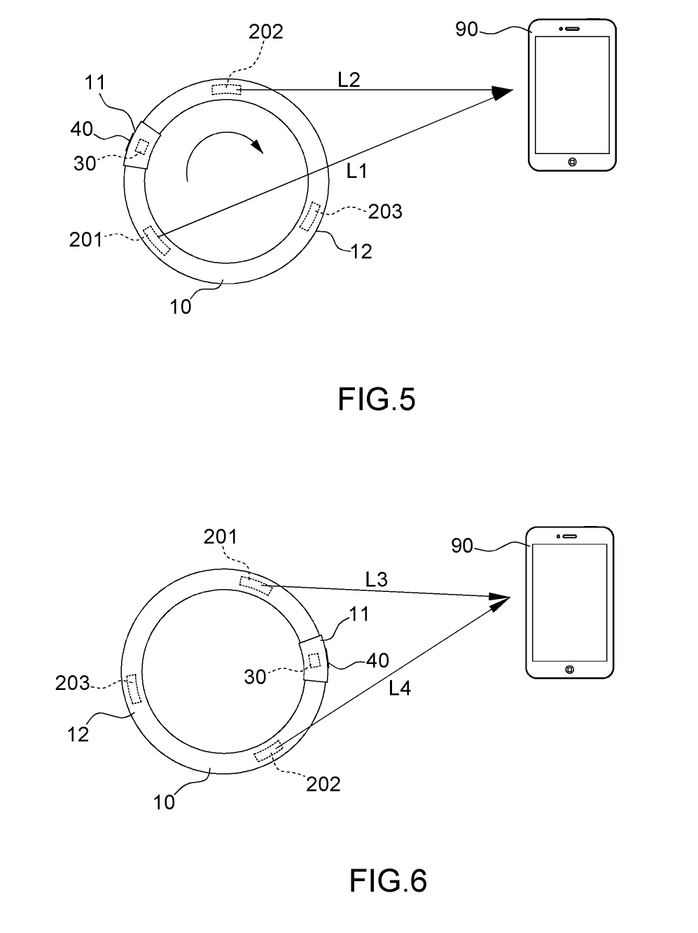

Now please refer to FIG. 3, which presents a flowchart of steps in a method for adjusting the direction of a head end according to the present invention. Please also refer to FIG. 2 and FIGS. 4-6. Specifically, FIG. 4 is a view showing an operation interface for the user to input a control command; FIG. 5 is a view showing that the head end of the aircraft body is not oriented toward the electronic device; and FIG. 6 is a view showing the head end of the aircraft body oriented toward the electronic device after rotation.

As shown in FIG. 3, the method for adjusting the direction of the head end of the present invention first executes Step S1: receiving a wireless signal transmitted from an electronic device by each of the antennas.

As shown in FIG. 4, when a user starts a software program loaded into the electronic device 90, the electronic device 90 will display an operation interface 92 on a screen 91 to allow a user to input a control command Specifically, the operation interface 92 includes a direction control button 921 and an altitude control button 923. The direction control button 921 allows the user to control the flight direction of the remote control aircraft 1, and the altitude control button 923 allows the user to control the altitude of the remote control aircraft 1.

When the user clicks the direction control button 921 to control the remote control aircraft 1 to fly in a particular direction, the electronic device 90 will issue a wireless signal to the remote control aircraft 1 according to the control command after receiving the control command input by the user. The wireless signal will be received by the antennas 20 on the remote control aircraft 1.

Then follows Step S2: determining whether the head end is oriented toward the electronic device according to the strengths of the wireless signals received by each of the antennas.

In Step S1, although all of the first antenna 201, the second antenna 202 and the third antenna 203 may receive the wireless signals transmitted from the electronic device 90, the direction of the head end 11 may not always be oriented toward the electronic device during the flight 90, so the distances from each of the antennas to the electronic device 90 will be different; as a result, the strengths of the wireless signals received by the first antenna 201, the second antenna 202 and the third antenna 203 may be different.

As shown in FIG. 5, for example, when the head end 11 of the aircraft body 10 is not oriented toward the electronic device 90, the distances from the antennas 20 to the electronic device 90 are different (L1>L2), and the strengths of the wireless signals received by the first antenna 201 and the second antenna 202 correspondingly disposed at the left and right sides will be different (since the distances from the first antenna 201 and the second antenna 202 to the head end 11 are equivalent). Therefore, when the strengths of the wireless signals received by the first antenna 201 and the second antenna 202 are different, it can be determined that the head end 11 of the aircraft body 10 is not oriented toward the electronic device 90. Furthermore, when the head end 11 of the aircraft body 10 is oriented away from the electronic device 90 (i.e., the tail end 12 is oriented toward the electronic device 90) and the electronic device 90 is located to the south of the remote control aircraft 1, the head end 11 of the aircraft body 10 will be oriented toward the north. At this time, even if the head end 11 is not oriented toward the electronic device 90, the distances from the first antenna 201 and the second antenna 202 to the electronic device 90 will be equivalent, so the placement of the third antenna 203 can assist in determining whether the head end 11 is oriented toward or away from the electronic device 90 at this time.

When the strengths of the wireless signals received by the first antenna 201 and the second antenna 202 are equivalent, the distances from the first antenna 201 and the second antenna 202 to the electronic device 90 are equal (L3=L4). At this time, if the strengths of the wireless signals received by the first antenna 201 and the second antenna 202 are greater than the strength of the wireless signal received by the third antenna 203, the control unit 30 determines that the head end 11 is oriented toward the electronic device 90. Conversely, if the strengths of the wireless signals received by the first antenna 201 and the second antenna 202 are equivalent and the strengths of the wireless signals received by the first antenna 201 and the second antenna 202 are less than the strength of the wireless signal received by the third antenna 203, the control unit 30 determines that the head end 11 is oriented away from the electronic device 90. It should be noted herein that if only the first antenna 201 and the second antenna 202 are provided, then when the strengths of the wireless signals received by the first antenna 201 and the second antenna 202 are equivalent, the control unit 30 can first control the head end 11 to rotate 180 degrees and then compare the strengths of the received signals to those before the rotation. If the strengths of the signals received by the two antennas 201, 202 before the rotation are greater, the difference indicates that the head end 11 was oriented toward the electronic device 90 before the rotation. Thus, at this time, the control unit 30 can control the head end 11 to rotate again such that the head end 11 is oriented toward the electronic device 90. Conversely, if the strengths of the signals received by the two antennas 201, 202 are greater after the rotation, the head end 11 is oriented toward the electronic device 90 after the rotation. At this time, the head end 11 is kept oriented in the direction of the electronic device 90.

Step S3: controlling the head end of the aircraft body to rotate.

In Step S2, when the control unit 30 determines that the head end 11 of the aircraft body 10 is not oriented toward the electronic device 90, the control unit 30 will control the head end 11 of the aircraft body 10 to turn toward the electronic device 90. Because the electronic device 90 constantly issues wireless signals (i.e., due to continuous clicking of the direction control button 921) when a user operates the remote control aircraft 1 to fly in a specific direction and the wireless signals can be received by the antennas 20, the control unit 30 will determine whether the head end 11 of the aircraft body 10 has turned toward the electronic device 90 (i.e., Step S1 and S2 are repeatedly performed) according to the aforementioned judgment mechanism after Step S3 is completed. If yes, the process moves to Step S4: keeping the head end oriented toward the electronic device. If not, the head end 11 of the aircraft body 10 is caused to rotate; steps 51 to S3 are performed repeatedly until the head end 11 of the aircraft body 10 turns toward the electronic device 90. When the head end 11 is oriented toward the electronic device 90 during flight, the control unit 30 will constantly receive wireless signals transmitted from the electronic device 90 by the antennas 20 (since the user will keep clicking the direction control button 921); the control unit 30 can adjust the direction of the head end 11 at any time according to the received wireless signals to keep the head end 11 oriented toward the electronic device 90 (that is, after Step S4 is performed, Steps S1, S2, S3 or S4 will be repeatedly performed too).

It should be noted that the method for adjusting the direction of a head end of the present invention is not limited to the sequence of the aforementioned steps. As long as the objectives of the present invention can be achieved, the order of the steps listed above can also be changed.

Through the implementation of the method for adjusting the direction of a head end of the present invention, the head end 11 of the aircraft body 10 can be ensured to be oriented toward a user when the user operates the remote control aircraft 1 to fly in a specific direction. Therefore, the user does not need to focus on the current direction of the head end 11 of the aircraft body 10 while operating the remote control aircraft 1, and the remote control aircraft 1 can fly in the direction which the user desires after rotation as long as the user clicks the direction control button 921 in accordance with his/her desire, which greatly enhances the convenience of user operation.

As described above, the objective, means, and efficiency of the present invention are all different from conventional characteristics in the prior art. It will be appreciated if the committee can review and grant a patent to benefit society. However, it should be noted that the described embodiments are only for illustrative and exemplary purposes, and that various changes and modifications may be made to the described embodiments without departing from the scope of the invention as disposed by the appended claims.

What is claimed is:

1. A method for adjusting the direction of a head end, applied to a remote control aircraft and used for adjusting the direction of a head end of an aircraft body of a remote control aircraft, such that the head end turns toward an electronic device, wherein the aircraft body comprises a plurality of antennas, the method comprising the following steps:
receiving a wireless signal transmitted from the electronic device by each of the antennas;
determining whether the head end is oriented toward the electronic device according to the strengths of the wireless signals received by each of the antennas;
if not, controlling the head end of the aircraft body to turn toward the electronic device; and
if yes, keeping the head end oriented toward the electronic device.

2. The method for adjusting the direction of a head end as claimed in claim 1, wherein the plurality of antennas comprise a first antenna and a second antenna which are correspondingly disposed at the left and right sides of the aircraft body, and the distance from the first antenna to the head end is equal to the distance from the second antenna to the head end.

3. The method for adjusting the direction of a head end as claimed in claim 2, wherein the plurality of antennas further comprise a third antenna, and the distance from the third antenna to the head end is greater than the distances from the first antenna to the head end and from the second antenna to the head end.

4. The method for adjusting the direction of a head end as claimed in claim 3, wherein the aircraft body further comprises a tail end which is opposite to the head end, and the third antenna is adjacent to the tail end.

5. The method for adjusting the direction of a head end as claimed in claim 3, wherein when the strengths of the wireless signals received by the first antenna and the second antenna are equivalent and greater than the strength of the wireless signal received by the third antenna, the method determines that the head end is oriented toward the electronic device.

6. The method for adjusting the direction of a head end as claimed in claim 3, wherein when the strength of the wireless signal received by the third antenna is greater than the strengths of the wireless signals received by the first antenna and the second antenna, the method determines that the head end is oriented away from the direction of the electronic device.

7. The method for adjusting the direction of a head end as claimed in claim 3, wherein when the strength of the wireless signal received by the third antenna is less than the strengths of the wireless signals received by the first antenna and the second antenna, the method determines that the head end is oriented toward the electronic device.

8. A remote control aircraft, capable of being remotely operated by a user with an electronic device, the remote control aircraft comprising:
an aircraft body, comprising a head end;
a plurality of antennas, disposed on the aircraft body and used for receiving a wireless signal transmitted from the electronic device; and
a control unit, disposed on the aircraft body and electrically connected to the antennas for determining whether the head end is oriented toward the electronic device according to the strengths of the wireless signals received by each of the antennas, and when the head end is not oriented toward the electronic device, controlling the head end of the aircraft body such that it is oriented toward the electronic device.

9. The remote control aircraft as claimed in claim 8, wherein the plurality of antennas comprise a first antenna and a second antenna which are correspondingly disposed at the left and right sides of the aircraft body, and the distance from the first antenna to the head end is equal to the distance from the second antenna to the head end.

10. The remote control aircraft as claimed in claim 9, wherein the plurality of antennas further comprises a third antenna, and the distance from the third antenna to the head end is greater than the distances from the first antenna to the head end and from the second antenna to the head end.

11. The remote control aircraft as claimed in claim 10, wherein the aircraft body further comprises a tail end which is opposite to the head end, and the third antenna is adjacent to the tail end.

12. The remote control aircraft as claimed in claim 10, wherein when the strengths of the wireless signals received by first antenna and the second antenna are equivalent and greater than the strength of the wireless signal received by the third antenna, the control unit determines that the head end is oriented toward the electronic device.

13. The remote control aircraft as claimed in claim 10, wherein when the strength of the wireless signal received by the third antenna is greater than the strengths of the wireless signals received by the first antenna and the second antenna, the control unit determines that the head end is oriented away from the direction of the electronic device.

14. The remote control aircraft as claimed in claim 10, wherein when the strength of the wireless signal received by the third antenna is less than the strengths of the wireless signals received by the first antenna and the second antenna, the control unit determines that the head end is oriented toward the electronic device.

15. The remote control aircraft as claimed in claim 8, further comprising a camera disposed at the head end.

16. The remote control aircraft as claimed in claim 8, wherein the aircraft body is a disc, the distances from the first antenna, the second antenna and the third antenna to the center of the disc are equivalent, and the angles between any two positions of the antennas and the center of the disc are 120 degrees.
